(19) United States
(12) Patent Application Publication
(10) Pub. No.: US 2009/0060183 A1
(43) Pub. Date: Mar. 5, 2009

(54) PRIVATE LOCK INFRASTRUCTURE

(75) Inventor: Richard C. Kim, Phoenix, AZ (US)

Correspondence Address: DUBOIS, BRYANT, CAMPBELL & SCHWARTZ, LLP, 700 LAVACA STREET, SUITE 1300, AUSTIN, TX, 78701, US

(73) Assignee: Dynasig Corporation, Phoenix, AZ (US)

(21) Appl. No.: 12/199,119

(22) Filed: Aug. 27, 2008

Related U.S. Application Data
(60) Provisional application No. 60/968,782, filed on Aug. 29, 2007.

(51) Int. Cl. H04L 9/00

(52) U.S. Cl. 380/255

(57) ABSTRACT

A method and system for securely transmitting data from a sender to a receiver wherein a private lock is created by a receiver. The private lock is freely distributable while the key remains with the receiver. To receive encrypted data, the lock is sent to the sender who uses the lock to encrypt data. The sender sends the encrypted data to the receiver. When the receiver receives the encrypted data, he can decipher the message using his own key. In cases where there are multiple intended recipients, each recipient sends their lock to the sender and the sender encrypts the same data with each of the locks. The sender then sends the encrypted data to each of the recipients. Each recipient uses their own key to access the data. In some instances, the locks will be recognizable and each receiver will be able to identify his own lock while in other instances the locks will not be recognizable and the user will not know how many locks are on the data or the types of locks that are being used. In those cases, the receiver can still apply his own key to all locks to see if any of the locks open. By using the method and system of the present invention, the transmissions of data is more secure because of the reduced risk of keys being shared, lost or stolen, the role of certificate authority is eliminated, and the role of registration authority becomes optional.

### CROSS-REFERENCE TO RELATED APPLICATIONS

This non-provisional application claims priority based upon prior U.S. Provisional Patent Application Ser. No. 60/968,782 filed Aug. 29, 2007, entitled “Bio-Pen Lockbox,” the disclosure of which is fully incorporated herein by this reference as if fully set forth herein in its entirety.

### BACKGROUND OF THE INVENTION

This invention relates generally to identity management and, more specifically, to systems and methods for securing data through the use of a private lock infrastructure as an alternative to the public key infrastructure.

Identity management is becoming increasingly important for electronic security and document control. There are a variety of methods of implementing identity management, such as the use of passwords or biometrics with a public key infrastructure (PKI), the use of secure socket layer (SSL) for secure transmission of information, the use of a myriad of standards and protocols for domain-specific communication and interaction of network enabled devices, the use of multi-level security, the use of vulnerability detection and protection mechanisms at the various network nodes, the use of appropriate policies for proper, improper and illegal usage of the system, the detection and prevention of such intrusions, and numerous others.

Security is commonly thought of in terms of locks and keys or combinations thereof. In the physical world, one lock can have several keys and those keys may be distributed among several people for secure entry and access. The “door” in the electronic domain would represent access to the digital data. The “key or combination” would be equivalent to a password. This concept is graphically represented in FIG. 1 wherein the computer information is stored in a vault 101 with a combination lock 102. The vault 101 may be opened using a combination 103. The combination 103 may be passed among many users, any of whom may access the vault.

### Encryption

Data that is merely password protected (similar to a combination lock) is vulnerable to attack in much the same way as a physical lock. For example, a potential thief could guess the password or the password could fall into the wrong hands. In addition, simply knowing the type of lock being used provides a significant amount of information regarding the type of key that is required to open it.

Encryption is a method of storing data in a form which is unintelligible without the encryption “key” as shown in equation (1)

E=F(D,K) (1)

Where D is the data to be encoded, K is the encryption key and E is the encoded cipher.

Decryption is the method of recovering the data D from E as shown in equation (2)

D=F′(E,K) (2)

In order to decrypt an encrypted message, the receiver of the information has to have prior knowledge of the secret encryption key K.

The use of F and F′ is valuable only if it is impractical to ascertain the data D from the encoded cipher E without the knowledge of the corresponding encryption key K. Referring now to FIG. 2, sender 200 generates data 201 that is encrypted using an encryption key 202 to create an encrypted cipher 203 (or vault) with a lock 204. A receiver 210, 220 receives the encrypted cipher 203 and uses the encryption key 202 to unlock or decrypt the lock 204 to decipher the data 201. Conceptually, the lock 204 is the same as the combination lock on the vault, decrypting or unlocking the lock 204 is conceptually the same as dialing the combination to unlock the lock, and deciphering is conceptually similar to opening the door on the vault. By analogy, one could have a strong vault or cipher but, if left unlocked, the vault can be opened at any time without the need to unlock the lock. It should be noted that the cipher could be broken without unlocking the lock which, once again by analogy, would be similar to breaking through the door without using the lock.

In most cases, using a reasonable algorithm for F and F′, simply attacking the encrypted cipher 203 to ascertain the encryption key 202 or breaking the lock 204 is very difficult. However, if the encryption key 202 must be shared among many receivers, especially in cases where the receivers are remote and possibly unverifiable, there is an increased likelihood that the encryption key 202 will be wrongfully acquired. The problem with safeguarding encrypted data, therefore, is as much a function of the safe storage and transfer of the encryption key 202 as the strength of the algorithm used to encrypt the data.

### Public Key Infrastructure (PKI)

Diffie and Hellman proposed an encryption and decryption protocol that eliminates the need for sharing the secret key information in public. They accomplish this using a pair of mathematically related keys called the public key K and a private key K′ such that the encryption and decryption are carried as shown in equations (3) and (4).

E=F(D,K) (3)

D=F′(E,K′) (4)

One key, the public key K, is used for encryption and the other key, the private key K′, is used for decryption. Even if one knows one key, it is not easy to calculate the other key.

This encryption and decryption protocol, commonly known as the public key infrastructure (PKI), has the following properties: a public key that is freely distributed and can be seen by all users; a corresponding (and unique) private key that is kept confidential; both the public and private keys are issued by a registration authority (RA); and each time a transaction is initiated, the user identity is authenticated by a certificate authority (CA).

Referring to FIG. 3, data 301 is encrypted using an encryption key 302 to create an encrypted cipher 303 with lock 305. The sender 300 sends the encrypted cipher 303 to receiver 310, 320 who uses a decryption key 304 to decipher the data 301.

In this case the decryption key 304 is a private key. However, even though the decryption key 304 is private and is not therefore compromised by distribution of the public encryption key 302, the private decryption key 304 still must be shared if multiple people are to access the same data 301. As a result, the problems associated with the safe storage and transfer of a key still remain.

In PKI, the function of the registration authority and the certificate authority can, and currently typically are, performed by a single entity. Therefore, the company that generates the digital certificates usually also provides certification services. However, it is desirable for these two functions to be separated for both security reasons and to avoid anti-competitive practices.

Usually, the sender of the data works with, and pays, the registration authority to generate the public/private key pair, or digital certificate. The receiver or receivers then work with the certificate authority to verify the digital certificate through, for example, identification of the sender, authentication of the contents, etc. In some instances the receiver pays a single certificate fee and in other cases a sender may pay some type of on-going subscription fee so that the digital certificates stay valid for a period of time. Since both the sender and receivers rely on the certificate authority for authentication, the digital certificate from PKI is only valid while there is some type of certificate authority service available and the digital certificate can expire at anytime. As a result, a secure peer-to-peer authentication is not possible without the certificate authority middleman.

Although the PKI and the use of the Diffie-Hellman protocol are accomplishing the original purpose for which they were designed, it is not at all clear the certificate authorities are truly adequate for secure communication. Certificate authorities neither guarantee the uniqueness of the digital certificate, nor can they protect distribution of the information by the user end, which is the weakest link in the whole process. Therefore, even though the private key is not compromised by distribution of the public key, the private key must be shared if multiple people are to access the same data.

As previously stated, the PKI framework also requires the need for a certificate authority who authenticates the users each time a transaction is executed. While the registration authority originally authenticates the user and issues the PKI certificate, it is the certificate authority who acts as the middleman for every transaction. Though this may be lucrative for certificate authority vendors, it is neither convenient nor cost effective for the communicating users. Moreover, the user is literally at the mercy of the certificate authorities. The key cannot be easily changed or if a private key (usually a password) is lost, or it has been damaged, it is a cumbersome process to initiate a new key. Also, one party could have access to another party's public key and, at a minimum, can pretend to be the other part and disrupt that party's communication.

One can understand the need for a registration authority that first issues the key and brings parties together. In the human communication paradigm, a common and trusted person known to each other brings two parties together, and then the two parties are left alone to communicate with each other.

A system and method for secure communications is therefore needed that is able to:
build on existing identity management infrastructure leveraging the resources levied upon it;
eliminate holes, redundancies, and unnecessary modes of operations in the existing infrastructure, while at the same time providing the same or similar capabilities as existing methods;
seamlessly provide peer-to-peer, point-to-point, centralized, and distributed authentication as well as identification capabilities without exorbitant loads on system capabilities or human intervention;
be cost effective in the sense that resource and infrastructure capabilities are used only as needed;
accommodate the multiple layers of security protection to allow for the proper flow of classified, unclassified, privileged, proprietary and/or public information seamlessly within the same channels and networks of communication;
allow for information assurance and traceability at any level of user roles and privileges;
work with existing protocols and mechanisms of encryption while accommodating future changes to legacy environment, information exchange protocol, and ease of use with minimal impact; and
be generally agnostic to encryption protocols, biometric devices and capabilities, and network protocols and advances.

### BRIEF SUMMARY OF THE INVENTION

The present invention provides a method for securely transmitting data from a sender to a receiver without the need for both public and private keys. Data is encrypted using a single lock or sets of locks which may be freely distributed. By using the method and system of the present invention, the transmission of data is more secure because of the reduced risk of keys being lost or stolen, the role of certificate authority is eliminated, and the role of registration authority becomes optional.

In one embodiment, a receiver initiates the process by generating a lock which is associated with his own private key. The receiver then sends the private lock to the sender and retains the private key. The sender encodes the data with the receiver's lock and sends the encrypted message to the receiver. When the receiver receives the message, he can decipher the message using his own private key.

In embodiments where there are multiple intended recipients, each recipient sends their lock to the sender and the sender encrypts the same data with each of the locks. The sender then sends the encrypted data to each of the recipients. Each recipient may potentially see many locks on the data. In some embodiments, the locks will be recognizable to the receiver and each receiver will be able to see the labels on the locks to find his own lock. In other embodiments, the locks will not be recognizable and the user will not know how many locks are on the data or the types of locks that are being used. In those cases, the receiver can still apply his own private key to all locks to see if any of the locks open.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a depiction of a physical lock and key combination;

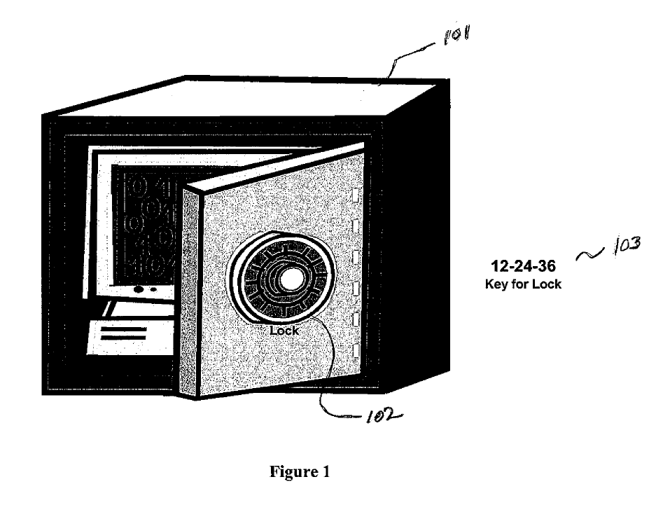

FIG. 2 is a block diagram representing an encryption model;

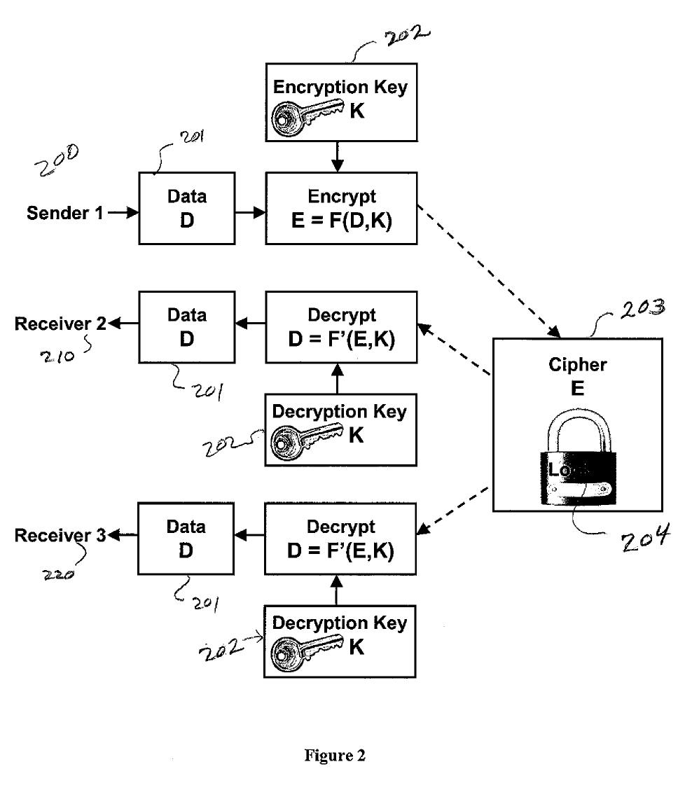

FIG. 3 is a block diagram representing a public key infrastructure model;

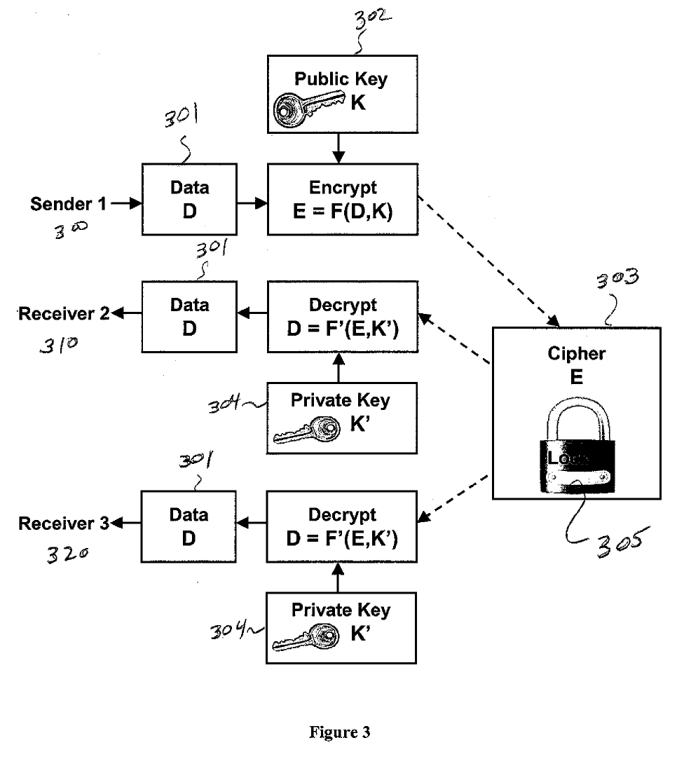

FIG. 4 is a block diagram representing one embodiment of the present invention; and

FIG. 5 is a depiction of another embodiment of the present invention using multiple types of keys.

### DETAILED DESCRIPTION

The present invention provides an improved method and system for securely transmitting data. The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention provides a novel framework for secure communication and data access by using a more flexible and robust backbone architecture to provide secure peer-to-peer, point-to-point, centralized or distributed, authentication and identification capabilities.

In the digital domain, locks and keys can be interchangeable. Instead of one door having one lock and several keys, it is entirely possible to conceive of a digital door with several locks and only one key that opens one of those locks. In this scenario, a door is associated with a pair lock and key; one person opens the door using a first key that fits a first lock, while a second person opens the same door using a second key that fits a second lock. Thus both people can have secure access to the contents behind the same door without disrupting and without compromising the other person's security.

The method and system of the present invention, sometimes referred to herein as a private lock infrastructure, is precisely such a mechanism. In the present invention, there is no more need for two types of keys: public keys and private keys. There is only one type of lock—a private lock—and that lock may be freely distributed. As a result, the role of certificate authority is eliminated and the role of registration authority becomes optional.

Rather than issuing multiple public and private keys as in the public key infrastructure, it is more efficient and less costly to have several locks on a single file and to allow only one private key per lock for a user. In certain embodiments, a registration authority may have the central authority to create, or alternatively to allow users to create, private locks and keys, and the registration authority can, at the mutual request of users, label private locks unique to each user for a chosen medium of communication and/or documentation, and then distribute it to them. Unlike keys, the locks of the present invention can be freely copied and distributed to anyone without breaching the security of the file. Once users are in possession of the private locks, they can encrypt many files with those locks and each receiver will have access to the common information by using his private key. The user does not need a certificate authority to act as a middleman to authenticate them for every transaction.

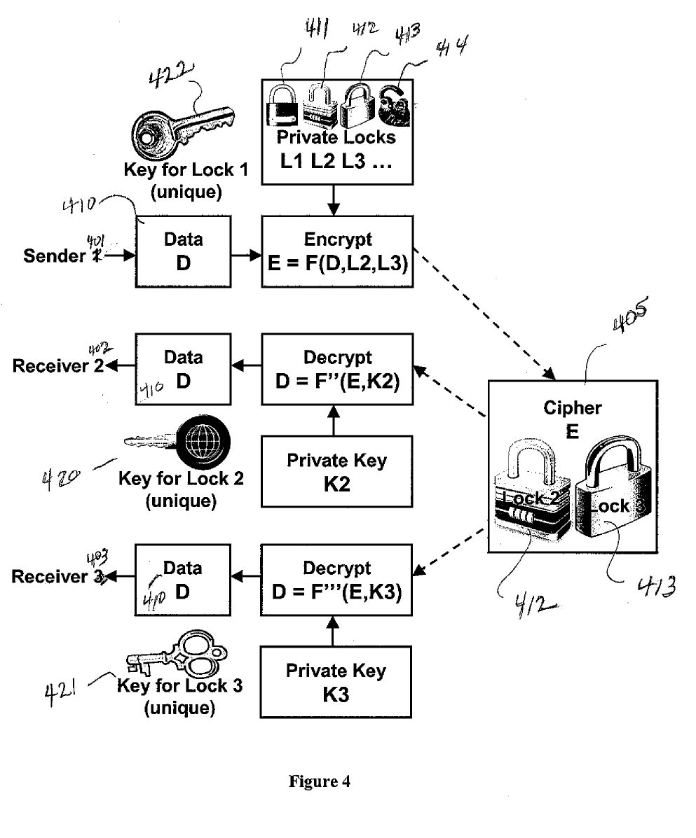

Referring now to FIG. 4, a sender 401 encrypts data 410 using one or more private locks 411, 412, 413, 414 to create an encryption cipher 405. Each private lock 411, 412, 413, 414 corresponds to an intended receiver while lock 411 and key 422 belong to the sender. For example, lock L2 412 may correspond to receiver 402 and lock L3 413 may correspond to receiver 403. The sender does not necessarily know what kinds of locks 411, 412, 413, 414 are being used. The sender 401 sends the encrypted cipher 405 to the receivers who use their own private key to decrypt the lock. For example, receiver 402 uses private key 420 to decrypt the encrypted cipher 405 and receiver 403 uses private key 421 to decrypt the encrypted cipher 405. When the receiver receives the message, he does not need to know the locks or keys used by the sender or any other receiver. He simply uses his own private key, a key which is not publicly distributed, to open his own lock.

Variations of the foregoing may also be useful. For example, a sender may encrypt data using private lock L2 to create a first encryption cipher and then encrypt that entire first cipher using locks L3 and L4 to create a second encryption cipher. In essence, the first cipher is nested inside the second cipher. In this case, the holder or holders of the keys paired to locks L3 and L4 would need to first decrypt locks L3 and L4 to open the second cipher and then the holder of the key paired to L2, which may or may not be the same party holding the key or keys for locks L3 and L4, could decrypt lock L2 to open the first cipher.

In one embodiment of the present invention, a receiver starts the process by generating their own private locks. In a pure peer-to-peer situation, the receiver sends his private lock to the sender, the sender then encodes the data with each of the intended receiver's private locks and sends the message. When the receiver receives the message, he will potentially see many locks on the message. In some embodiments, the locks will be recognizable and the receiver will be able to see the labels on the locks to find his own lock. In other embodiments the locks will not be recognizable and the user will not know how many locks are on the data or the types of locks that are being used. In those cases, the receiver can still apply his own private key to all locks to see if any of the locks open.

In another embodiment, all senders and receivers would register their locks with a registration authority. The registration authority would function as the central repository of the locks would maintain and update the list of locks. If a sender needs locks for his message, he could either: (1) download all the locks needed from the registration authority or (2) use the list from the registration authority to generate the message. In the first case, once the locks have been downloaded, meaning the sender now has the private locks saved on his local computer, the need for the registration authority stops and all users can start their own communications. In the second case, the registration authority maintains the list so the burden is not on the user to keep the list updated.

In one embodiment of the present invention, the authentication mechanisms, or private locks, are contained within the data being transmitted. Accordingly, a certificate authority does not need to verify that a receiver has the right to access the data. Also, it is no longer necessary for the digital certificate to expire because the users themselves use their own private key mechanism for verification.

In commercial implementations, most individual users probably will not want the burden of maintaining their own private lock lists which will provide a market for registration authorities. On the other hand, large companies, institutions and/or government may elect to serve as their own registration authority. In addition, users will have the ability to choose among a variety of private lock mechanisms (such as fingerprint, iris, voice or signature) which will enable different technology companies to sell their lock generation mechanisms to the customers.

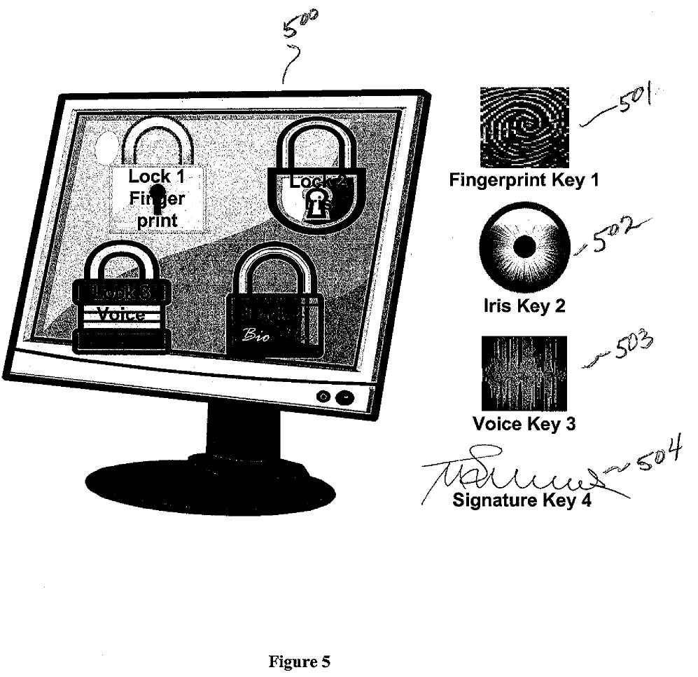

In other embodiments of the invention, the private locks can have totally different biometric characteristics. Referring now to FIG. 5, a digital file is locked using one or more of a fingerprint, an iris, a voice or a signature. There may also be multiple locks using the same type of lock (e.g. ten fingerprint locks). The receiver who has the fingerprint key 501 would be able to access the file, the receiver who has the iris key 502 would be able to access the file, the receiver who has the voice key 503 would be able to access the file, and the receiver who has the signature key 504 would be able to access the file. Although each of the four receivers has different keys and they didn't share any information about their keys or locks, each one is able to access the same file.

In practice, the embodiment of the invention described above would enable different organizations with different biometric modalities to each access the same data, or portions of the same data, with their own unique private locks and keys. In other words, the same locked file sent to four different people could be accessed by different modalities: receiver 1 uses a fingerprint key, receiver 2 uses an iris key, receiver 3 uses a voice key and receiver 4 uses a signature key, and each one would have access to the same data.

For example, a first organization may use fingerprint scans as part of its employee identity management protocol and a second organization may use iris scans as part of its employee identity management protocol. A member of the first organization who wanted to send data to a member of the second organization would use an iris scan to encrypt the data. When the user in the second organization receives the data, he would use his iris key to open the data. If the user in the second organization wanted to send the data back to the member of the first organization, he would simply return the file with the fingerprint lock on it. When the user in the first organization receives the data, he can access the data using his fingerprint key even though he has no ability to access the data using the iris scan.

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise.

When a single embodiment is described herein, it will be readily apparent that more than one embodiment may be used in place of a single embodiment. Similarly, where more than one embodiment is described herein, it will be readily apparent that a single embodiment may be substituted for that one method or device.

In light of the wide variety of possible methods for identity management, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

What is claimed is:

1. A method for the secure transmission of data comprising:
a receiver creating a lock and key pair;
said receiver transmitting said lock to a sender;
said sender encrypting data using said lock to create an encryption cipher;
said sender transmitting said encryption cipher to said receiver; and
said receiver using said key to decrypt said lock.

2. The method of claim 1, wherein the type of said lock and/or the method of operating said lock is unknown to said sender.

3. The method of claim 1 further including the use of one or more additional locks when encrypting said data to create said encryption cipher.

4. The method of claim 1 wherein said lock incorporates one or more tokens.

5. The method of claim 1 wherein said lock incorporates one or more of a fingerprint, an iris, a voice, or a signature.

6. A method for the secure transmission of data comprising:
a first party creating a lock and key pair;
said first party transmitting said lock to a sender and transmitting said key to a receiver;
said sender encrypting data using said lock to create an encryption cipher;
said sender transmitting said encryption cipher to said receiver; and
said receiver using said key to decrypt said lock.

7. The method of claim 6 wherein said third party is an organization that employs, or contracts with, said receiver.

8. A method for the secure transmission of data comprising:
a receiver creating a lock and key pair;
said receiver transmitting said lock to a registration authority;
a sender desiring to send data to said receiver retrieving said lock from said registration authority;
said sender encrypting data using said lock to create an encryption cipher;
said sender transmitting said encryption cipher to said receiver; and
said receiver using said key to decrypt said lock.

9. The method of claim 8 further including the use of one or more additional locks when encrypting said data to create said encryption cipher.

10. The method of claim 9 wherein said receiver is unaware of the presence and/or type of locks used on said encryption cipher.

11. A method for the secure transmission of data comprising:
a lock and key pair;
transmitting said lock to a sender;
encrypting data using said lock to create an encryption cipher;
transmitting said encryption cipher to said receiver; and
using said key to decrypt said lock.

12. A method for the secure transmission of data comprising:
receiving a lock from a receiver who has created a lock and key pair;
encrypting data using said lock to create an encryption cipher;
transmitting said encryption cipher to said receiver, wherein said receiver uses said key to decrypt said lock.

13. A method for the secure transmission of data comprising:
a receiver creating a lock and key pair;
said receiver transmitting said lock to a sender wherein said sender encrypts data using said lock to create an encryption cipher and sends said encryption cipher to said receiver; and
said receiver using said key to decrypt said lock.

14. A system for the secure transmission of data comprising:
a sender; and
a receiver, wherein said receiver creates a lock and key pair, transmits said lock to a sender for sender's use in encrypting data with said lock to create an encryption cipher, receiving said encryption cipher, and decrypting said lock using said key.

15. The system of claim 14, wherein the type of said lock and/or the method of operating said lock is unknown to said sender.

16. The system of claim 14 further including the use of one or more additional locks when encrypting said data to create said encryption cipher.

17. The system of claim 14 wherein said lock incorporates one or more of a fingerprint, an iris, a voice, or a signature.

18. A method for the secure transmission of data comprising:
creating a first lock paired to a first key and a second lock paired to a second key;
using said first lock to encrypt data in a first encryption cipher;
using said second lock to encrypt said first encryption cipher into a second encryption cipher;
transmitting said second encryption cipher to one or more receivers wherein one of said one or more receivers uses said second key to decrypt said second lock and open said second cipher and the same or another of said one or more receivers uses said first key to decrypt said first lock and open said first cipher.
